(19) United States
(12) Patent Application Publication
(10) Pub. No.: US 2018/0338602 A1
(43) Pub. Date: Nov. 29, 2018

(54) PORTABLE COSMETIC ORGANIZER CASE

(71) Applicant: Dania Marrero, Doral, FL (US)

(72) Inventor: Dania Marrero, Doral, FL (US)

(21) Appl. No.: 15/990,583

(22) Filed: May 25, 2018

Related U.S. Application Data
(60) Provisional application No. 62/510,974, filed on May 25, 2017.

(51) Int. Cl. A45D 40/24; A45C 11/00; A45C 13/02; G09B 19/00

(52) U.S. Cl. CPC A45D 40/24; A45C 11/008; A45D 2040/202; G09B 19/00; A45D 2200/25; A45C 13/02

(57) ABSTRACT

A portable cosmetic case is disclosed herein. The portable cosmetic case includes a housing, at least one flap portion, a securing means and a plurality of fold-out holders. The portable cosmetic case is useful for providing an organized system of storing cosmetics, and for providing a cosmetic case which is easily insert-able into a purse.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of cosmetic cases and more specifically relates to portable cosmetic cases having plural cosmetic or applicator compartments.

### 2. Description of Related Art

Cosmetics are care substances used to enhance the appearance or odor of the human body. They are generally mixtures of chemical compounds, some being derived from natural sources, while others may be synthetic. Cosmetics that are meant to be used on the face and eye area are usually applied with a brush, a makeup sponge, or the fingertips. Many cosmetic products are large and bulky and take up a significant amount of space in current cosmetic cases, makeup bags or handbags, while other products are small and easily misplaced amongst items inside of handbags, cosmetic cases or storage drawers.

Traditionally, cosmetic cases have been used to organize, secure, transport and store various cosmetic items such as mascara, lipstick, brushes, lip gloss, lip liner, eye liner, tweezers, curlers, powders, blush, eyeshadows, creams, skin-care and other related and similar products. Many women store their makeup products in a bag or case where all of the items rest in the bottom of the bag. In order to locate a specific item, individuals must dig through all of the items. This can be a difficult task, especially when in the car or otherwise on the go. Many times an individual's make up bag has to be large to accommodate all of their items. This can prevent the bag from being able to travel easily or fit into a purse. Thus, a suitable solution is desired.

U.S. Pat/Pub. No. 2011/0073130 to Lori A. Reynolds relates to a cosmetic organizer. The described cosmetic organizer includes a base layer adapted for secure coupling to an interior panel disposed within a cosmetic organizer; a sheet disposed upon the base layer and adapted to be operatively marked with at least one notation by a user of the cosmetic organizer to identify at least one adjacent cosmetic by an attribute of the cosmetic; a translucent layer disposed upon the sheet and adapted to cover the sheet and to protect the marked sheet, yet provide visibility of the notation to the user; and a top layer disposed upon the translucent layer and adapted to secure the sheet and the translucent layer to the base layer.

### BRIEF SUMMARY OF THE INVENTION

In view of the foregoing disadvantages inherent in the known cosmetic cases art, the present disclosure provides a novel portable cosmetic organizer case. The general purpose of the present disclosure, which will be described subsequently in greater detail, is to provide a portable cosmetic organizer including dual compartments and for the insertion into a purse. One of the compartments may store eye products and lip products, and the other compartment may store face products. Within the eye and lip compartment there may be individual trays or pockets for each lipliner or eyeliner. The face product compartment may be circular in shape to provide easier access to a compact power. The face product compartment may also include pockets or trays for foundation. The portable cosmetic organizer may include a built-in sharpener. The organizer may also be adjustable.

A portable cosmetic case is disclosed herein. The portable cosmetic case includes a housing which may have a top surface, a bottom surface, an inner chamber, and a spine. The top surface may be pivotally attached to the bottom surface via the spine. Further, at least one flap portion may be included within the housing. The at least one flap portion may have a first end and a second end. The first end of the elongate body may be located on the bottom surface and the second end of the elongate body may be removably attached to the top surface of the housing.

Further, a securing means may be provided. The securing means may have a male end and a female end, the female end being attached to the second end of the elongate body and the male end being attached to the top surface of the housing. The securing means may be configured to keep the portable cosmetic case in a closed position. In addition, the portable cosmetic case may include a plurality of fold-out holders disposed about a perimeter of the housing and the plurality of fold-out holders may configured to hold cosmetic products.

A method of using portable cosmetic case is also disclosed herein. The method of using portable cosmetic case may comprise the steps of: providing the portable cosmetic case as above; storing at least one of a plurality of lip products, a plurality of eye products and a plurality of face products within the inner chamber; securing the at least one of the plurality of lip products, the plurality of eye products and the plurality of face products in the inner chamber via at least one of the plurality of securement-loops; further storing the at least one of the plurality of lip products, the plurality of eye products and the plurality of face products within at least one of the at least one flap-portion and the plurality of fold-out holders; and using the securing means to secure the portable cosmetic case in the closed position.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a portable cosmetic organizer case, constructed and operative according to the teachings of the present disclosure.

FIG. 1 is a prospective view of the portable cosmetic case during an ‘in-use’ condition, according to an embodiment of the disclosure.

FIG. 2 is a side view of the portable cosmetic case of FIG. 1, according to an embodiment of the present disclosure.

FIG. 3 is a front view of the portable cosmetic case of FIG. 1, according to an embodiment of the present disclosure.

FIG. 4 is a prospective view of the portable cosmetic case of FIG. 1, according to an embodiment of the present disclosure.

FIG. 5 is a prospective view of the portable cosmetic case of FIG. 1, according to an embodiment of the present disclosure.

FIG. 6 is a flow diagram illustrating a method of use for portable cosmetic case, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to cosmetic cases and more particularly to a portable cosmetic organizer case as used to improve the portable cosmetic cases having plural cosmetic or applicator compartments or receivers.

Generally, disclosed is a purse-size makeup organizer for use when traveling or for placement in a bag or purse. The organizer may include individual compartments with pockets designed to hold eyeliner, lipstick, mascara, face products, and more. This may offer convenience for women by providing a makeup case that affords accessibility to essential products. Thus, eliminating the need to dig through an over-sized makeup bag looking for an item. The organizer may allow users to easily and quickly access makeup while on the go, including a built-in sharpener.

The organizer may be comprised of a wallet style case/purse with two sides. Each side may be divided with trays/pockets for easy organizing. One of the sides may be designed to store lip and eye products, while the other side may hold face products. The organizer may be adjustable and may also include a built-in sharpener for lip and eye pencils. Additional fold-out holders may be placed around the edges of the case for additional items. Further, the organizer may include a closure strap with a snap or Velcro, zipper pouches, an elastic seal for foundation, a pop-up lever compact holder, expandable pockets, and more. The case may be made from leather or other suitable material.

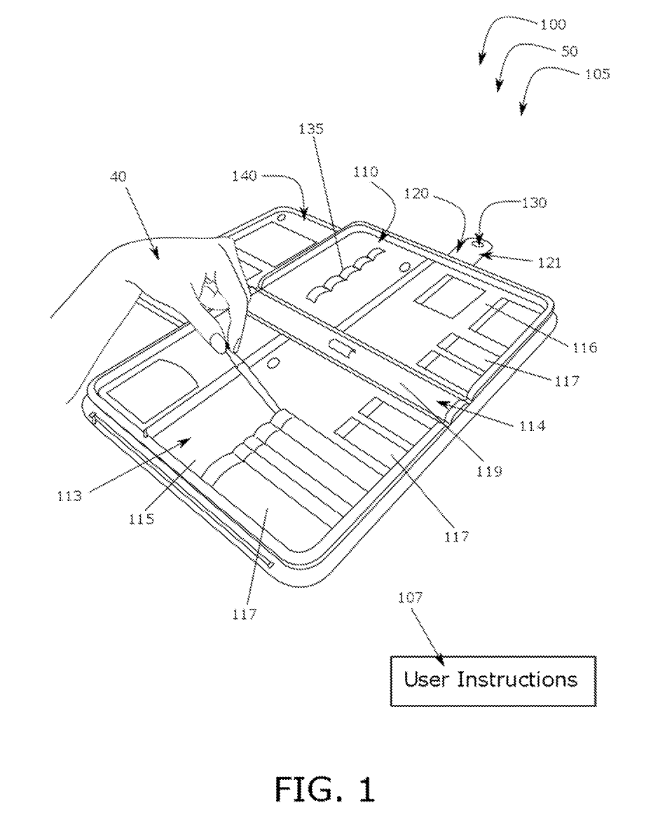

Referring now more specifically to the drawings by numerals of reference, there is shown in FIGS. 1-4, various views of a portable cosmetic case 100.

FIG. 1 shows a portable cosmetic case 100 during an ‘in-use’ condition by a user 40, according to an embodiment of the present disclosure. As illustrated, the portable cosmetic case 100 may include a housing 110, at least one flap portion 120, a securing means 130, and a plurality of fold-out holders 140. As illustrated, the portable cosmetic case 100 may be configured to provide an organized system of storing cosmetics.

According to one embodiment, the portable cosmetic case 100 may be arranged as a kit 105. The kit 105 may include a set of instructions 107. The instructions 107 may detail functional relationships in relation to the structure of the portable cosmetic case 100 (such that the portable cosmetic case 100 can be used, maintained, or the like, in a preferred manner).

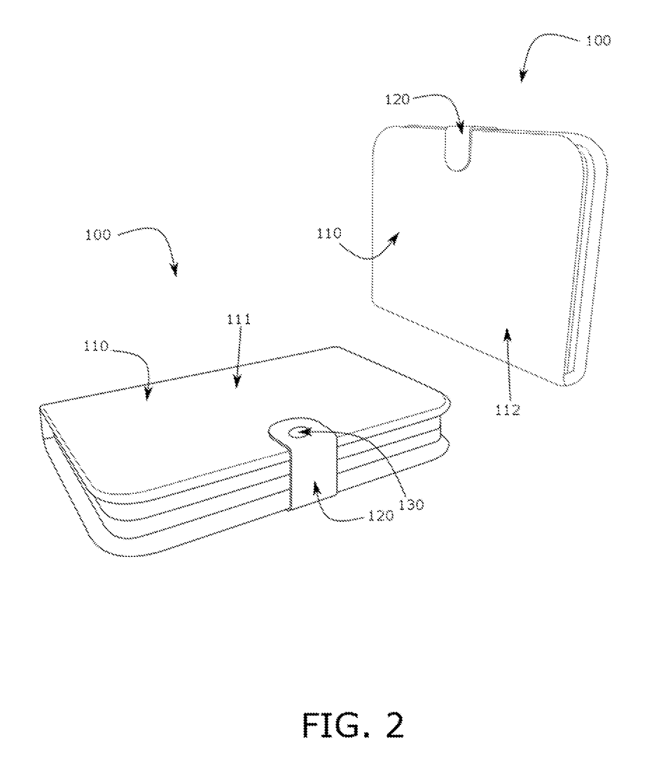

FIG. 2 shows a side view of the portable cosmetic case 100 of FIG. 1, according to an embodiment of the present disclosure. Illustrated here is the portable cosmetic case in a closed position. As shown, the housing 110 may include a top surface 111, a bottom surface 112, an inner chamber 113, and a spine 114, the top surface 111 being pivotally attached to the bottom surface 112 via the spine 114. In a preferred embodiment, the housing 110 may be made from a leather material. Examples of leather material may be suede leather, cow leather, lambskin leather, or in some embodiments faux leather. In a further embodiment, the housing 110 may be made from a plastic material. Other examples of materials to be used for the housing 110 may include silicone, canvas, moleskin, microfibre, vinyl, and the like.

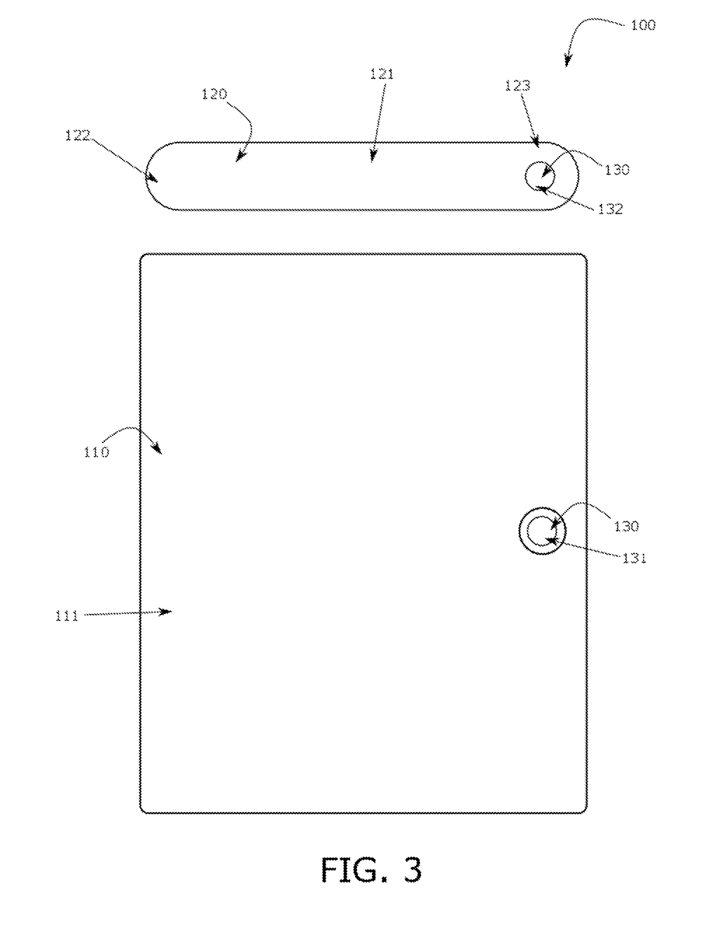

FIG. 3 shows a front view of the portable cosmetic case 100 of the at least one flap portion 120 and the securing means 130. As illustrated, the at least one flap portion 120 may include an elongate body 121, the elongated body including a first end 122 and a second end 123. The first end 122 of the elongate body 121 may be located on the bottom surface 112 and the second end 123 of the elongate body 121 may be removably attached to the top surface 111 of the housing 110.

The securing means 130 may include a male end 131 and a female end 132, the female end 132 being attached to the second end 123 of the elongate body 121 and the male end 131 being attached to the top surface 111 of the housing 110. As illustrated, the securing means 130 may be configured to keep the portable cosmetic case 100 in a closed position. In a preferred embodiment, the securing means 130 may be a snap-fastener. In another embodiment, the securing means 130 may be a button. Other examples of securing means 130 may include buckles, hook-and-eye closures, hook and loop fasteners, zippers, and the like.

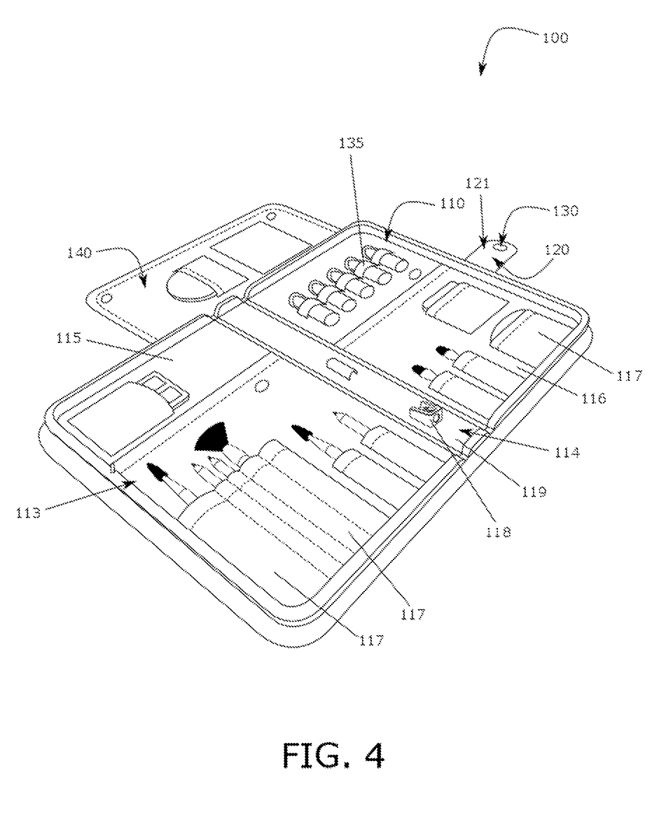

FIG. 4 shows a top view of the portable cosmetic case 100 of FIG. 1, according to an embodiment of the present disclosure. Shown here is the portable cosmetic case 100 including the inner chamber 113 and storing cosmetics. The inner chamber 113 may be defined by a left portion 115 and a right portion 116. The left portion 115 may be configured to store a plurality of lip products and a plurality of eye products, and similarly, the right portion 116 may be configured to store a plurality of lip products and a plurality of eye products. Further, the left portion 115 and the right portion 116 may be configured to store a plurality of face products. In addition, the left portion 115 and the right portion 116 may include a plurality of pockets 117. In one embodiment, the plurality of pockets 117 may be expandable. The inner chamber 113 may include a sharpener 118 fixedly attached to an inner portion 119 of the spine 114 and configured to sharpen a plurality of lip pencils 15 and a plurality of eye pencils 10.

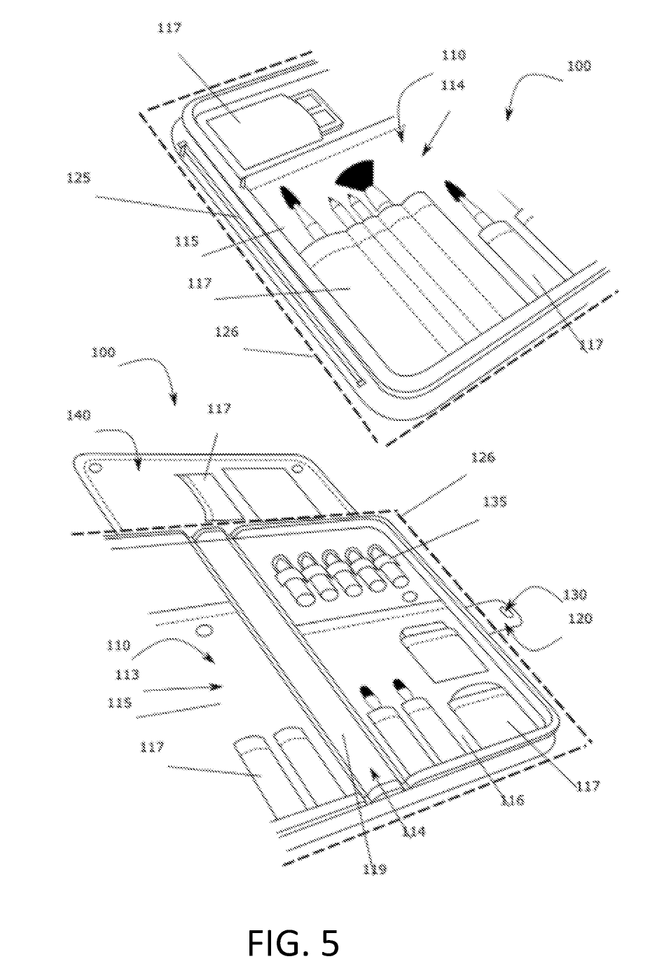

Referring now to FIG. 5 showing various views of the portable cosmetic case 100 of FIG. 1, according to an embodiment of the present disclosure. As illustrated, the housing 110 may further comprise at least one zipper pouch 125. The at least one zipper pouch 125 may be located on an outside border of the housing 110 and may extend from an upper end of the housing 110 to a lower end of the housing 110. At least one of the left portion 115 or the right portion 116 may further include a plurality of securement-loops 135 configured to secure the plurality of lip products, the plurality of eye products and the plurality of face products. Further, as demonstrated, the plurality of fold-out holders 140 may be disposed about a perimeter 126 of the housing 110 (here, one fold-out holder is shown) and configured to hold cosmetic products.

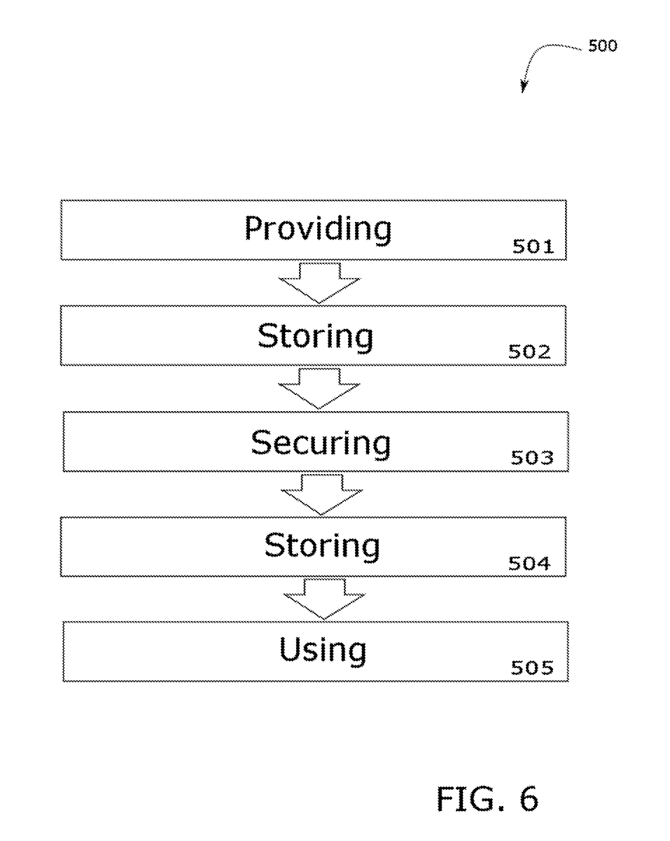

FIG. 6 is a flow diagram illustrating a method of using a portable cosmetic case 500, according to an embodiment of the present disclosure. As illustrated, the method of using a portable cosmetic case 500 may include the steps of: step one 501, providing the portable cosmetic case 100 as above; step two 502, storing at least one of a plurality of lip products, a plurality of eye products and a plurality of face products within the inner chamber 113; step three 503, securing the at least one of the plurality of lip products, the plurality of eye products and the plurality of face products in the inner chamber 113 via at least one of the plurality of securement-loops 135; step four 504, further storing the at least one of the plurality of lip products, the plurality of eye products and the plurality of face products within at least one of the at least one flap-portion and the plurality of fold-out holders 140; and step five 505, using the securing means 130 to secure the portable cosmetic case 100 in the closed position.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for portable cosmetic case 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A portable cosmetic case, said portable cosmetic case comprising:
a housing, said housing having a top surface, a bottom surface, an inner chamber, and a spine, wherein said top surface is pivotally attached to said bottom surface via said spine;
at least one flap portion, said at least one flap portion having an elongate body and wherein said elongate body has a first end and a second end, and wherein said first end of said elongate body is located on said bottom surface and wherein said second end of said elongate body is removably attached to said top surface of said housing;
a securing means, said securing means having a male end and a female end, said female end being attached to said second end of said elongate body and said male end being attached to said top surface of said housing, and wherein said securing means is configured to keep said portable cosmetic case in a closed position;
a plurality of fold-out holders, said plurality of fold-out holders disposed about a perimeter of said housing and wherein said plurality of fold-out holders is configured to hold cosmetic products; and
wherein said portable cosmetic case is configured to provide an organized system of storing cosmetics.

2. A portable cosmetic case of claim 1, wherein said inner chamber is defined by a left portion and a right portion.

3. A portable cosmetic case of claim 2, wherein said left portion and said right portion includes a plurality of pockets.

4. A portable cosmetic case of claim 3, wherein said plurality of pockets is expandable.

5. A portable cosmetic case of claim 3, wherein said left portion is configured to store a plurality of lip products and a plurality of eye products.

6. A portable cosmetic case of claim 3, wherein said right portion is configured to store a plurality of lip products and a plurality of eye products.

7. A portable cosmetic case of claim 3, wherein said left portion is configured to store a plurality of face products.

8. A portable cosmetic case of claim 3, wherein said right portion is configured to store a plurality of face products.

9. A portable cosmetic case of claim 1, wherein said securing means is that of a snap-fastener.

10. A portable cosmetic case of claim 9, wherein said securing means is a button.

11. A portable cosmetic case of claim 1, wherein said housing is made from a leather material.

12. A portable cosmetic case of claim 1, wherein said housing is made from a plastic material.

13. A portable cosmetic case of claim 1, wherein said inner chamber has a sharpener fixedly attached to an inner portion of said spine and configured to sharpen a plurality of lip pencils and a plurality of eye pencils.

14. A portable cosmetic case of claim 1, further comprising at least one zipper pouch.

15. A portable cosmetic case of claim 14, wherein said at least one zipper pouch is located on an outside border of said housing.

16. A portable cosmetic case of claim 15, wherein said at least one zipper pouch extends from an upper end of said housing to a lower end of said housing.

17. A portable cosmetic case of claim 1, wherein at least one of said left portion and said right portion further include a plurality of securement-loops configured to secure said plurality of lip products, said plurality of eye products and said plurality of face products.

18. A portable cosmetic case, said portable cosmetic case comprising:
a housing, said housing having a top surface, a bottom surface, an inner chamber, and a spine, wherein said top surface is pivotally attached to said bottom surface via said spine;
at least one flap portion, said at least one flap portion having an elongate body and wherein said elongate body has a first end and a second end, and wherein said first end of said elongate body is located on said bottom surface and wherein said second end of said elongate body is removably attached to said top surface of said housing;
a securing means, said securing means having a male end and a female end, said female end being attached to said second end of said elongate body and said male end being attached to said top surface of said housing, and wherein said securing means is configured to keep said portable cosmetic case in a closed position;
a plurality of fold-out holders, said plurality of fold-out holders disposed about a perimeter of said housing and wherein said plurality of fold-out holders is configured to hold cosmetic products; and
wherein said portable cosmetic case is configured to provide an organized system of storing cosmetics;
wherein said inner chamber is defined by a left portion and a right portion;
wherein said left portion and said right portion includes a plurality of pockets, and wherein said plurality of pockets is expandable;
wherein said left portion is configured to store a plurality of lip products and a plurality of eye products;
wherein said right portion is configured to store the plurality of lip products and the plurality of eye products;
wherein said left portion is further configured to store a plurality of face products;
wherein said right portion is further configured to store the plurality of face products;
wherein said securing means is that of a snap-fastener;
wherein said housing is made from a leather material;
wherein said inner chamber has a sharpener fixedly attached to an inner portion of said spine and configured to sharpen a plurality of lip pencils and a plurality of eye pencils; and
wherein the portable cosmetic case further comprises at least one zipper pouch;
wherein said at least one zipper pouch is located on an outside border of said housing; and
wherein said at least one zipper pouch extends from an upper end of said housing to a lower end of said housing; and
wherein at least one of said left portion and said right portion further include a plurality of securement-loops configured to secure said plurality of lip products, said plurality of eye products and said plurality of face products.

19. The portable cosmetic case of claim 18, further comprising set of instructions; and
wherein the portable cosmetic case is arranged as a kit.

20. A method of using a portable cosmetic case, the method comprising the steps of:
providing the portable cosmetic case including:
a housing, said housing having a top surface, a bottom surface, an inner chamber, and a spine, wherein said top surface is pivotally attached to said bottom surface via said spine, wherein said inner chamber further includes a left portion and a right portion and wherein said left portion and said right portion further include a plurality of securement loops;
at least one flap portion, said at least one flap portion having an elongate body and wherein said elongate body has a first end and a second end, and wherein said first end of said elongate body is located on said bottom surface and wherein said second end of said elongate body is removably attached to said top surface of said housing;
a securing means, said securing means having a male end and a female end, said female end being attached to said second end of said elongate body and said male end being attached to said top surface of said housing, and wherein said securing means is configured to keep said portable cosmetic case in a closed position;
a plurality of fold-out holders, said plurality of fold-out holders disposed about a perimeter of said housing and wherein said plurality of fold-out holders is configured to hold cosmetic products;
storing at least one of a plurality of lip products, a plurality of eye products and a plurality of face products within the inner chamber;
securing the at least one of the plurality of lip products, the plurality of eye products and the plurality of face products in the inner chamber via at least one of the plurality of securement-loops;
further storing the at least one of the plurality of lip products, the plurality of eye products and the plurality of face products within at least one of the at least one flap-portion and the plurality of fold-out holders; and
using the securing means to secure the portable cosmetic case in the closed position.
